(19) United States
(12) Patent Application Publication
(10) Pub. No.: US 2003/0069693 A1
(43) Pub. Date: Apr. 10, 2003

(54) Geographic pointing device

(76) Inventors: Douglas N. Snapp, Orem, UT (US); Wayne Rust, Lindon, UT (US); Evan Ivie, Provo, UT (US)

Correspondence Address: KARL R CANNON, PO BOX 1909, SANDY, UT, 84091, US

(21) Appl. No.: 10/233,105

(22) Filed: Aug. 28, 2002

Related U.S. Application Data
(63) Continuation of application No. 10/052,894, filed on Jan. 15, 2002.
(60) Provisional application No. 60/262,147, filed on Jan. 16, 2001.

(51) Int. Cl. G01C 21/28

(52) U.S. Cl. 701/213; 701/207; 340/993

(57) ABSTRACT

A geographic pointing device that includes a GPS receiver, a digital compass and informational databases. When a user activates the device, the user's position and direction are displayed on a displayed map, as the user travels, the map and direction are continually updated to reflect the movement. Geographically encoded information concerning points of interest is displayed on the map in response to user preferences.

### CROSS-REFERENCE TO RELATED APPLICATIONS

This is a continuation of application Ser. No. 10/052,894, filed Jan. 15, 2002, which claimed the benefit under Section 119(e) of provisional application Serial No. 60/262,147, filed Jan. 16, 2001, which are each hereby incorporated by reference herein in their entireties, including but not limited to those portions that specifically appear hereinafter, the incorporation by reference being made with the following exception: In the event that any portion of the above-referenced applications are inconsistent with this application, this application supercedes said applications.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to systems for accessing data correlated with a geographic location, and more particularly to systems for accessing data correlated with a geographic location and directional information.

2. Description of Related Art

It is a common practice to attempt to provide users with information that is specific to a given geographic location or region. Guidebooks and maps for traveling, hiking, and other such activities have been produced for many areas. Recently, attempts have been made to provide such information in electronic form. This allows interested users to access information from one location, without having to consult a large number of separate guides. Such electronic access has typically required the user to have access to a personal computer. This can inconvenience a traveler, and may require that a portable laptop computer connected to a network, or printed pages of the computer-accessed information, be carried by the user.

Attempts have been made to overcome these problems. Devices known as Personal digital assistants (PDAs), such as the Palm Pilot® series of PDAs and the Handspring Visor® PDA, are in widespread use and provide a portable data carrying device. PDAs are generally used to contain an electronic calendar, and an address book that may be carried by users in a small package. It has become common to include additional features in a PDA, such as a cellular phone, or additional data. This is often done through the use of an accessory module that attaches to the PDA.

There are known modules that attach to a PDA and can provide maps that are usable to navigate a car on a trip, once a position is known. There are also known modules that provide the PDA with the ability to give the location of the user through the use of a global positioning system (GPS) interface. Neither of these systems however provides further information about the location. Even if a system providing access to the GPS and a map is used, the user must then figure the relationship between the location and the map. Determining directions in an unfamiliar location may be difficult, or impossible in some cases, without known landmarks. Such systems also only provide one standard set of information, but not information that is unique to preferences of the individual user.

It is also known for the PDA to be a computer system. This communication may be made by a wireless connection, or a “hot sink” connection. Such as by a cable linking the PDA to a personal computer. This allows information from a computer network to be placed into the PDA, and information in the PDA to be entered into the computer network. In this way, information about a geographic location may be placed into the PDA, but this requires the user to locate the information and convert it into a form that may be acceptable to the PDA.

It is noteworthy that none of the prior art known to applicant provides a system for providing information, including maps and directional information, about a geographic location based on user preferences, by operation of a portable device than can access the system from any location.

The prior art is thus characterized by several disadvantages that are addressed by the present invention. The present invention minimizes, and in some aspects eliminates, the above-mentioned failures, and other problems, by utilizing the methods and structural features described herein.

### BRIEF SUMMARY AND OBJECTS OF THE INVENTION

It is therefore an object of the present invention to provide a system for furnishing both positional information and directional information in connection with a map in one electronic device that is easily portable.

It is also an object of the present invention to provide a user with data that is unique to that user's interests or preferences with regard to a geographic location.

It is another object of the present invention to provide such a system that may be accessed by the user at a remote location, when the user does not have access to a computer network.

The above objects and others not specifically recited are realized in a specific illustrative embodiment of a geographic pointing device that includes a GPS receiver, a digital compass and informational databases. When a user activates the device, the user's position and direction are displayed on a displayed map, as the user travels, the map and direction are continually updated to reflect the movement. Geographically encoded information concerning points of interest is displayed on the map in response to user preferences.

Additional objects and advantages of the invention will be set forth in the description which follows, and in part will be apparent from the description, or may be learned by the practice of the invention without undue experimentation. The objects and advantages of the invention may be realized and obtained by means of the instruments and combinations particularly pointed out in the appended claims.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a perspective view of one embodiment of a geospatial module made in accordance with the principles of the present invention;

FIG. 2 is a flow chart of an embodiment of one method of standardizing data into a database in accordance with the principles of the present invention;

FIG. 3 is a flow chart of one embodiment of a method of providing information in accordance with the principles of the present invention.

### DETAILED DESCRIPTION OF THE INVENTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

It is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It must be noted that, as used in this specification and the appended claims, the singular forms “a,” “an,” and “the” include plural referents unless the context clearly dictates otherwise.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps.

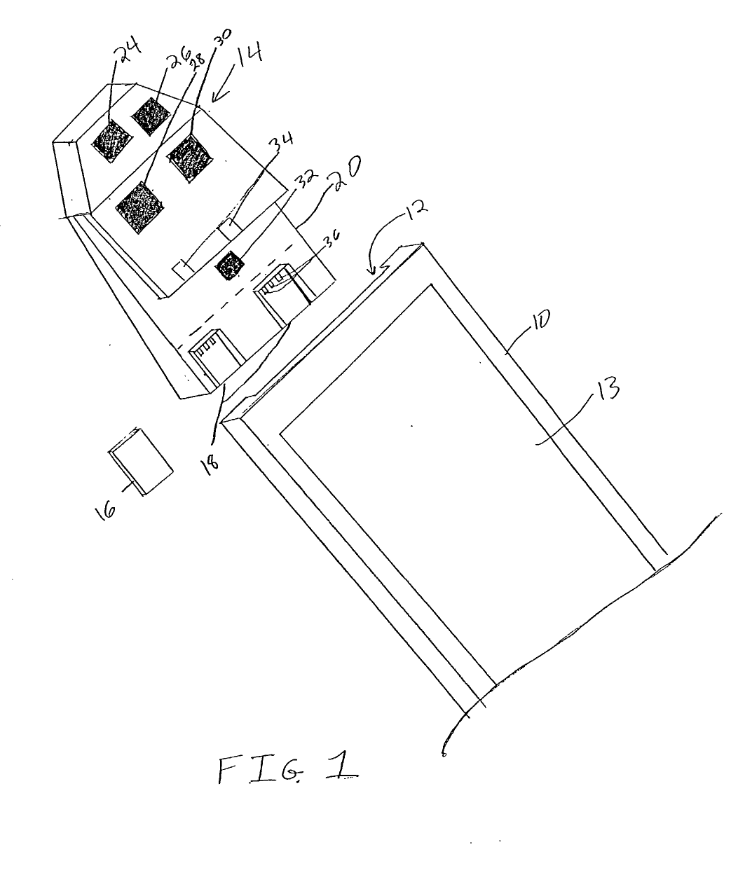

Referring now to FIG. 1, there is shown a perspective view of an embodiment of a device that may be used to interface with the system of the present invention. A hand held computing device such as a PDA (personal digital assistant) 10 contains a slot 12 for the connection of a module. The PDA 10 may be any commercially available PDA, and a preferred version is the Handspring Visor PDA manufactured by Handspring. The PDA 10 further includes a display 13. A geospatial module 14 is shown that can be inserted into slot 12. It is preferred that the geospatial module 14 have a back extension 20 that extends down the rear surface 11 of the PDA 10. It is further preferred that the back extension 20 be configured to provide a support for the PDA 10, when the PDA 10 is placed on a flat surface.

A removable memory card 16 may be inserted into one or more expansion slots 18 to allow the geospatial module 14 to store a larger amount of information. The removable memory card 16, may be a flash memory card, a SONY® Memory Stick™, a mobile memory card (MMC) as known in the field or any other removable data storage media.

The geospatial module 14 contains a locator means for determining the location of the unit, which is represented by the black box at 24. Preferably the locator means 24 is a GPS receiver that enables the latitude, longitude and elevation of the geospatial module 14 to be determined by receiving signals from the GPS satellites. It is also preferred that the geospatial module 14 contain a direction means for determining geographic directions with respect to the unit, represented by black box 26. Preferably the direction means 26 comprises a compass. More preferably, the direction means 26 comprises a digital compass including a single axis magnetic sensor. One such single axis magnetic sensor can be provided by Honeywell sensor chip HMC 1021. Most preferred is a digital compass that comprises a two axis magnetic sensor. One suitable two axis magnetic sensor is provided by Honeywell sensor chip HMC1022. It will be appreciated that these are merely examples of acceptable sensors and that any suitable sensor known to those skilled in the art may be used.

It is preferred that the geospatial module 14 include a tilt sensing means, generally represented as black box 28, allowing the direction means to function 26 in any position. The preferred tilt sensing means 28 is a two axis tilt sensor, one such suitable sensor is provided by Analog Devices as ADXL202E8. It will be appreciated that any suitable tilt sensing means 28 can be used.

It is further preferred that the geospatial module 14 include a temperature sensing means, generally represented as black box 30. The temperature sensing means 30 allows the geospatial module 14 to measure the ambient temperature at its location. It is preferred that the temperature sensing means 30 comprise a digital thermometer. One such suitable digital thermometer is provided by National Semiconductor as National LM61.

Other preferred embodiments of the geospatial module 14 will include a digital azimuth sensor. Some preferred embodiments of the geospatial module 14 include a power indicating means such as LEDs that indicate power available. The geospatial module 14 may be powered by disposable batteries, rechargeable batteries or any other suitable power source, known to those skilled in the art. Additionally, embodiments may include an inertial guidance device which may calculate the direction and speed of the unit. Other embodiments may include audio and/or video outputs, of the digital camera.

The geospatial module 14, also preferably contains a digital processing unit (DPU), represented by the black box shown as 32, for processing the signals received and generated by the other components, as well as for receiving and outputting data to the PDA 10. The DPU also controls the communications with the PDA. The geospatial module 14 also includes the contacts 34 necessary for making electrical connection with the PDA 10 for exchanging data. Some preferred embodiments include electrical connectors 36 for making connection with the removable memory cards 16.

It will be appreciated that the geospatial module, as shown in FIG. 1, is just one of a number of embodiments that can be constructed under the principles of the present invention. Embodiments where the functional parts are contained within a PDA are also included within the scope of the present invention, as are modules adapted to attach to a portable laptop or desktop computer.

One aspect of certain embodiments of the present invention separating it from the prior art is that it contains an element that can act as a “trigger.” This element, which can be embedded in the software to act on demand, or can be a component of the hardware such as a digital signal processor (DSP), starts and stops a device made in accordance with the principles of the present invention to determine both the location and direction of the device.

In certain embodiments, data is entered into the geospatial module 14 when the PDA 10 is linked to a computer, that is linked to a network. Data may also be entered into the geospatial module 14 through installation of memory cards 16. In still other embodiments, it is preferred that the geospatial module 14 contain wireless communications components to allow for communication with the system. It will be appreciated that in such wireless communicating embodiments the geospatial module 14 and PDA 10 may be used as an interface means to access a information system in accordance with the principles of the present invention.

In some preferred embodiments, the geospatial module 14 may include a scanner that reads data from printed characters, bar codes, or other computer readable formats.

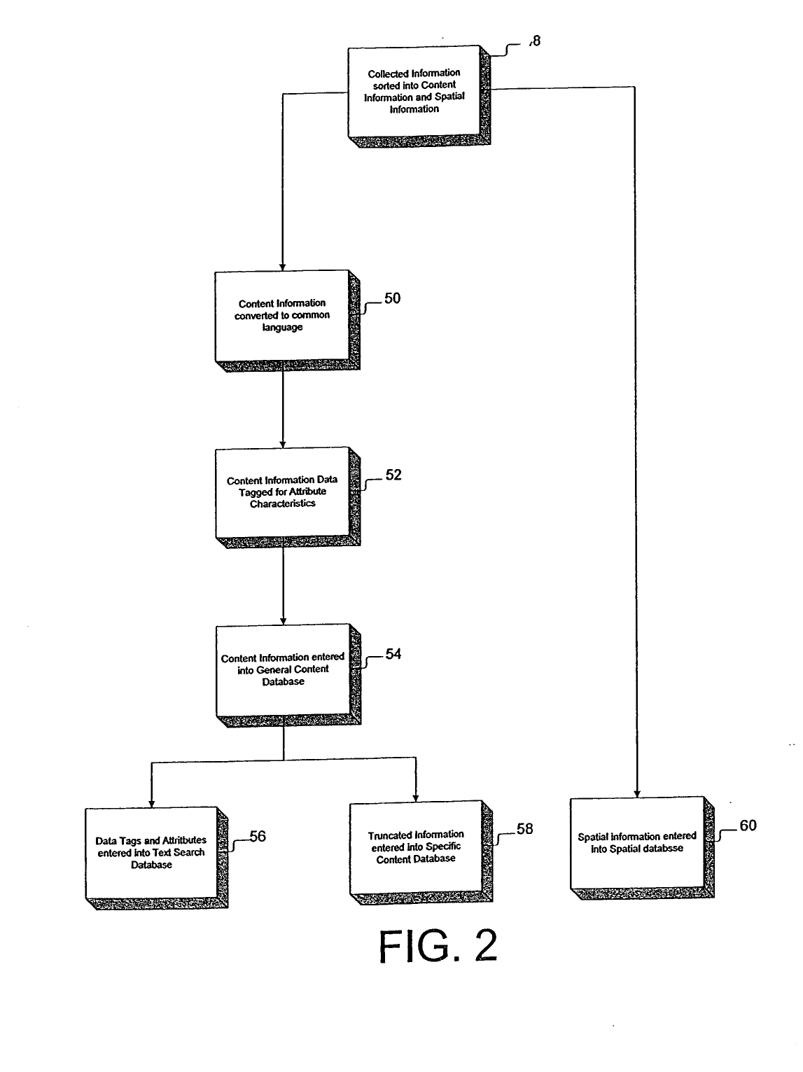

Referring now to FIG. 2 there is shown a plan of how content data is collected and stored in a database that may be accessed in a system in accordance with the principles of the present invention. As shown in box 48 collected information is sorted into spatial information and content information. Spatial information will be discussed further below. Content information consists of non-spatial information that may be of interest to users of the system, or device, and which may contain a geographical component. Content information is converted into a common format language, as shown in box 50. A preferred common format language is extensible markup language (XML), which is a computer language standardized to handle networked data and managed by the World Wide Web Consortium. Information on XML can be found in Extensible Markup Language (XML) 1.0 (Second Edition), W3C Recommendation Oct. 6, 2000 which is incorporated herein by reference in its entirety. It is further preferred that the common format language be GeoXML, which was developed is adapted for location specific computing. Applicant plans to submit the GeoXML standard to appropriate bodies to provide it as an open standard.

As the content information collected is converted into a common format language, the content information is data tagged for attribute characteristics as shown in box 52. These attribute characteristics include environmental attributes and characteristic attributes. Examples of environmental attributes include: location in terms of horizontal (latitude, longitude) and vertical (altitude), speed, direction the consumer is moving and/or the direction the consumer is facing, proximity to actual or virtual geographic entities, time and season, and current environmental conditions such as, temperature, barometric pressure, relative humidity weather conditions and trends, wind speed, traffic conditions, air conditions, fire conditions, water level, etc, as well as any other appropriate environmental attributes. These data tags thus includes geographically specific information.

Examples of characteristic attributes are information about the data that may be used to determine the type of user who would be interested in that data, or to classify the data. Examples of such characteristic attributes include, the form of the data (text, pictorial), the contents of the data, and the relationship of the data to components of user profiles, which are discussed below.

Once the content information is converted into the common language and data tagged, the data is entered into a general content database as represented in box 54, where it is cross-referenced by the data tags. This allows the data to be searched by the data tags, including location, type of data, content of data, interest to a specific type of user, etc.

As shown in box 56 a text search database, or index is generated from the general contents database. This text search database contains the data tags and other reference information, in order to allow for efficient searching. The information may be searched (and retrieved) by location, speed, direction of movement, proximity to the user, time and season, current environmental conditions, attributes of the information, or any other suitable condition or qualification.

As shown in box 58 a specific content data base is also generated, which contains information from the general content database in truncated form. The information in the specific content database is cross-referenced by the data tags and only differences between a base information set for a set of geographic data tags and later sets of information with those same geographic data tags is stored. This allows all the information sets from the general content database that are associated with a set of geographic data tags to be recreated without the need for storing duplicate information sets in the specific content database.

Since content information is stored in the databases in a common language, this allows information providers to submit updated data directly to the general content database. This allows for the database to be continually updated. For example, a restaurant listed in the database may update its menu on a daily basis. If a information provider is also an end user, the database may be updated by the usage.

Spatial information is also collected into a spatial database, as shown in box 60. Spatial information consists of maps or other guides that may be displayed to navigate an area.

When a user connects the PDA 10 with the geospatial module 14 installed to a computer network that may be connected to the databases shown in FIG. 2, the user may download information form those databases. The information may be downloaded by linking the PDA 10 to a network via a cable connection, through wireless communications when the PDA 10 or geospatial module 14 is so equipped, or through any other suitable means known now or in the future to those skilled in the art.

The user downloads information that is of interest to that user from the databases. Alternatively, the user may also input information of interest by entering the information into the display of the PDA, or by downloading the information from a removable memory card 16. The information is entered into a specific content database, a text search database, and a spatial database that are contained in the geospatial module 14 and PDA 10. This information may be stored in the memory of the PDA, the memory of the geospatial module 14 or a removable memory card 16.

It will be this process of creating databases that may be easily searched and contain geographically encoded information in a common language may be practiced on any computer system that is capable of doing the required conversions, processing and database handling.

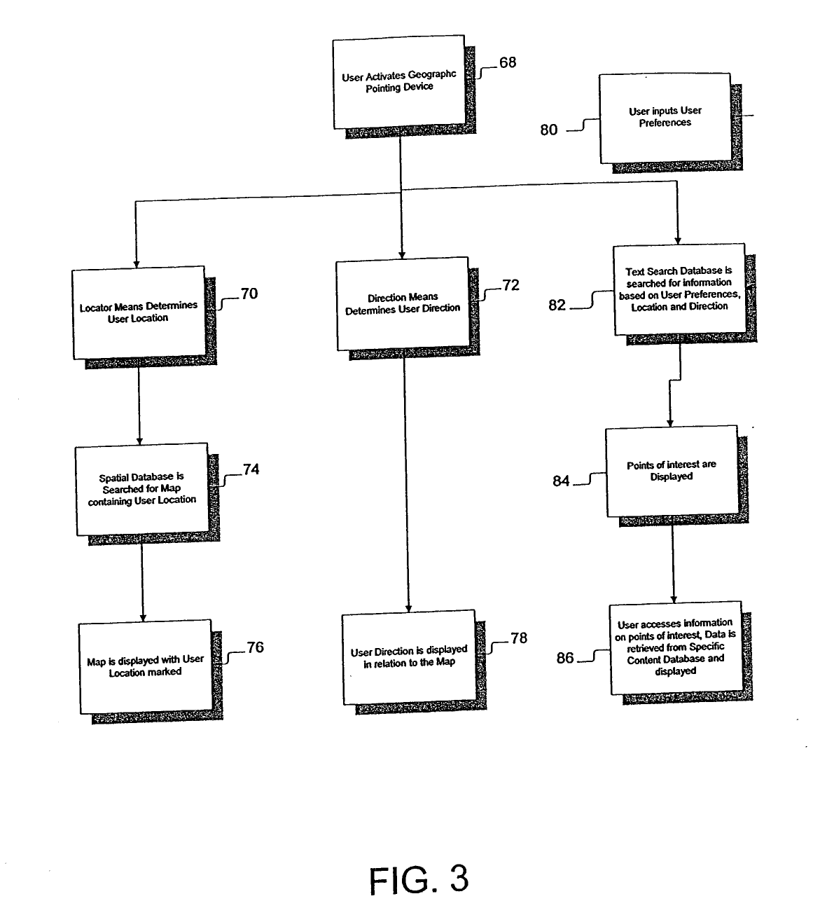

FIG. 3 illustrates the basic process followed when a user activates the device, as shown in box 68, and searches the databases. It will be appreciated that the steps shown are not fixed, that the steps may be taken in differing order, that the information in the databases may be directly searched without the need for location and direction, and that the user may modify the basic steps to fit that user's particular needs. It will be further appreciated that the illustrated steps may be followed wether the user searches the databases contained with the geospatial module 14 and PDA 10, or the larger databases via a wireless communication.

As shown in box 70, the location of the user is determined by the locator means 24. In the preferred embodiments this is accomplished by the GPS receiver located in the geospatial module 14. It will be appreciated that alternative methods may be used to determine the user location, and that the user may optionally use the interface to search a different location than the user's the location. This allows for the user to search an area to which the user is traveling, prior to arrival. As shown in box 74, once the user's location, or desired location is known, the spatial database is searched to obtain a map of the area in which the user is located. The map is then displayed on the screen 13 with the user's position marked on the map, as shown in box 76.

As shown in box 72, the user's direction in relation to the points of the compass is determined by the direction means 26. The user's direction is then displayed in relation to the displayed map as shown in box 78. The direction may be displayed in relation to the map in any of a number of suitable ways. For example, the location of the user may displayed as an arrow which always points in one direction, preferably north. Alternatives include indicating the direction of the top of the PDA 10 by the direction of the arrow, rotating the map so the top of the PDA is always facing the upper edge of the map displayed, or merely listing the directions at the bottom of the map. Any suitable relation display may be used. As the user travels, the direction sensor and location sensor may stay active, or activate at predetermined intervals to keep this information current.

The user creates a set of user preferences as shown in box 80. This may be done by entry of preferences on a checklist, or by active tracking of the categories which a user searches. In active tracking, information about a user is also gathered to form a user profile for that user, in preferred embodiments, this user profile is stored in the geospatial module 14, although it may be stored as part of the database. This user information includes the profile attributes of the user. Profile attributes include: activities, profession, hobbies, knowledge and scientific interests, arts and literature, ancestry and heritage, memberships or affiliations, citizenship, age and gender, purchase interests, product or service sales interests, brand preferences, computing platform, viewing medium preferences, language, disabilities, family age/size, pets, skills, mode of travel preferences, cuisine/food preferences, entertainment preferences, and other demographics, as well as any other useful user information. The user profile may then be converted to an algorithm that is used to search the database.

It is preferred that the user preferences be a simple checklist that is created by the user, before or during the activation of the device, in order to determine the information displayed. For example, the user may set the preferences to display restaurants, hiking trails, museums, or any other points of interest to that user.

As shown in box 82, the text database is searched by using the location and the user preferences. Information is presented to the user in relation to its proximity and interest to that user. It is preferred to present this information through the use of icons on the displayed map, as shown in box 84. The user may then obtain further information by accessing the icons that are displayed, or by performing a textual or other search of the Text Search of Specific Content databases for information related to the user's location, or the user's interests. When such information is accessed, the information is recreated from the specific content database in its untruncated form and displayed to the user on the screen 13, as shown box 86.

It will be appreciated that one advantage of the present system is that it allows the user to input additional points of interest to that user and those points are then contained in the appropriate databases.

In some embodiments, as the user makes search requests, the type of information requested is used to modify the user profile. This allows for information of interest to the user to be presented in the initial search rather than requiring additional searches. As a user's interests change, through development of different hobbies, or changes in the user's lifestyle, the user profile is continually updated, without the need for the user to register an updated user profile.

One advantage of the use of the common language is that the results of the search are presented in the common language. This allows for a customized presentation of the search results to be made, based upon the operating system that is used to publish the results. While any suitable operating system means may be used, it is preferred that Palm OS, Wireless-WAP, Wireless-3G, Pocket PC, that a DOS or Microsoft Windows based system be used. In a preferred embodiment, a client level browser that is operated in an identical manner regardless of the operating system is used to provide a standard method of conducting searches and accessing the database.

It will be appreciated that any data access or data storage device which is capable of performing the functions of establishing a desired location, the user's direction with respect to the points of the compass and database searching may be used to accomplish the retrieval of geographically encoded information with respect to the user's position and direction. All such systems are included within the scope of the present invention.

In one preferred usage, the PDA 10 with the geospatial module 14 installed may be used for routing of travel. The database is searched for maps based upon the location of the user. The map is displayed on the screen 11 of the PDA. The location of the user as established by the GPS locator is displayed on the map. In preferred embodiments where the geospatial module 14 contains a compass, the user's direction is also displayed. A route for travel may be marked on the map and items of interest to the user may be highlighted, allowing the user to access information about these items. Applicant knows of no other system that allows for this type of routing to be accomplished.

A method of mapping geospatial information to a resource or service is also included in the present invention. In one embodiment, a database is searched for information about a specific resource or service, or a type of resource or service. The results of the search are provided with the location information of the resource or service. The search may include location queries, or proximity queries for a particular service, among many other options, and the results may be reported in terms of the proximity of the location of each service among many other possible reporting methods, including location data.

The present invention also includes a method of recording environmental or other data at a physical location and storing that data in a database, including location data, to allow the locations and data to be stored and the conditions to be recreated in a computer environment. This method includes the steps of placing one or more interface means (such as a geospatial module installed in a PDA) that includes both an ability to measure at least one environmental condition and a locator means at a physical location (or at points around a physical location), the interface means then measures the environmental condition and transmits that data to a computer system. One or more conditions may be measured, including temperature, humidity, wind speed, or a photographic image. When transmitted the data is converted into a common language, and is tagged with location data. In preferred embodiment the data is then entered into a database. Users can then access that data to recreate the physical location in a computer simulation or report, including the environmental conditions. The data may be continually collected, or collected at specified intervals. In preferred embodiments, the interface means includes a plurality of environmental condition locators and a GPS unit serves as the locator means.

Also included within the scope of the present invention is a method for securing computer data based on geographic location. In this method, information stored in a database is correlated with data tags that include location data. The database either stored in a portable unit including a locator means such as a PDA with GPS capability, or is accessed through the portable unit serving as an interface means including locator means. If the database is accessed remotely, the portable interface means communicates with the database via a server, either through a direct connection or by wireless communication. The portable unit, portable interface means, or network server only allows access to data, or only allows encrypted data to be unencrypted, when the portable unit is located at specific geographic locations. The geographic locations may include a geographic area, and unique user profiles may be used to allow access to the data at different locations for different users. If the data is encrypted, it may be encrypted by any suitable means known now, or in the future, to those skilled in the art.

In preferred embodiments, this system may require tamper resistant portable units. Any structure or method for making the portable units tamper resistant may be used, but it is preferred to use a tamper resistant casing, which either causes the interface means to fail if opened, or is filled with an epoxy blocking access to the circuit boards even if the case is opened.

This method may be used to allow for a specific digital signature to be attached to information stored on a computer system, or network. A portable unit, including an encryption key, may be used to enter information into a network. Attached the information is an encrypted data tag, which includes the identity of the user who entered, or created, the information and the location of the interface means at the time the information was created and entered into the network. An information file may include such data tags generated each time a file is opened. This would allow the location and identity of each user who has worked on, or accessed, an information file on the network to be known, as well as the time at which the file was accessed.

One advantage of the disclosed system and device is that additional information obtained by the user, either guidebooks, maps, translators, and other information, that are in computer readable form, such as on disk, or downloaded from the World Wide Web may be converted into the common language and entered into the databases for that user.

Utilizing the system, methods, and apparatus that are included in various embodiments of the present invention, a number of unique methods can be practiced. Each of these methods is included within the scope of the present invention.

In accordance with the principles and combinations outlined above, the present invention includes a method for associating computer content, computing resources, or computing services with one or more absolute points in space. This may be practiced by associating the computer content, resource or service with a data tag containing computer readable geo-encoding tag. In some embodiments, this is accomplished by converting the information into a common language including the data tags. In the preferred embodiments the common language is XML, in more preferred embodiments it is GeoXML.

Also included in the scope of the present invention is a method comprising the steps of:

(a) geographically encoding data items by associating a geographic location with each data item;

(b) organizing geographically encoded data items into a database;

(b) searching such the database; and

(c) providing the results of the search organized by geographic location.

The present invention further includes a method of creating a user interface based upon the orientation and location of the device. In some embodiments, this is done by determining the location of the device and the orientation of the device, and generating a graphical interface showing nearby landmarks or other location based information, and its proximity and direction from to the device. In preferred embodiments the location and orientation are provided by a GPS receiver and a compass located in a geospatial module. In more preferred embodiments the geospatial module is attached to a PDA that includes a screen on which the graphical interface may be displayed.

The above-described arrangements are only illustrative of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

The apparatus is a location receiver direction sensor combination receiver apparatus for location determination and orienting with a plurality of points and axes of reference. The apparatus includes a global positioning system (GPS) for determining the geographic location, a direction sensor (MS) for determining direction or bearing, and a trigger component for activating the apparatus.

The apparatus also includes a data processing unit, a method wherein the trigger provides an event to occur, a method wherein the trigger provides an alert to be registered, a memory storage unit, and a visual output device or laptop screen or PDA screen. The visual output display or device may include a digital camera. The apparatus also includes a method for displaying digital content within a viewport in which the visual output device comprises the viewport. The digital content could be historic visual information. Further, the apparatus may include a method wherein the data that is going to the visual output device and the data coming in from the digital camera is combined in the memory store. The key to this method is that the location, bearing and angles of inclination of the digital picture and the digital content could be derived and used to create an historically accurate digital image of a place and an object at a particular location or plurality of locations or areas.

The apparatus may also include a communication channel, a network or plurality of location receivers and direction sensor combination apparatus of the apparatus that includes a communication channel, wherein the individual nodes of the network of apparatus can offer and request services, data or information from other nodes. Additionally, the network of location receivers and direction sensor combination apparatus include a method wherein the position, location, bearing, directions, and other information from any of the nodes of the network are exchanged and stored in either one node or replicated on any number of a plurality of nodes and, further, when any one of the said data items changes, an alert or notification is sent to one or a plurality of nodes in the network. Those nodes are alerted because of their request for an alert upon a data change event.

The apparatus also includes a method of abstracting the information between the apparatus and computer applications, a method of abstracting the information between the apparatus and the data store, a method of abstracting the data, timing, and control information between the apparatus and any other hardware system. The method would include a mapper for the exchange of the data, timing, and control information.

The present invention relates generally to the field of systems for tracking and positioning an entity or target, such as a vehicle or person, by surveillance or tracking persons or stations. More particularly, this invention relates to a mobile tracking and positioning system in which a mobile target is tracked by two or more mobile tracking and positioning stations continuously as all the elements of the system (i.e., the target and the tracking and positioning stations) move about or over the surface of the earth. Some typical applications of the invention are in the private security and transportation industries, where the location of a person or vehicle (or persons and fleets of vehicles) are monitored; the recovery of stolen vehicles; and in government applications such as surveillance, intelligence or counterterrorism, where a person or vehicle is positioned and tracked by police or military units.

Additional Description of Related Art

Prior art tracking and position systems fall into three general categories: homing systems with one or several homing vehicles, triangulation systems using two fixed points to locate the target, and triangulation systems using one or more fixed points together with a homing vehicle. Each has its own limitations and drawbacks.

Homing systems with mobile vehicles typically use arrows in the vehicle cockpit with a direction-finding apparatus. Some detector of proximity to the target is also involved. These systems have no real precision location or mapping capabilities. The present invention provides real-time precision mapping and locating of the target by mobile tracking stations.

Stationary triangulation systems are inherently inflexible, as the position of the triangulation stations is fixed. Ideally, the tracking units should have the flexibility to move about in the surveillance and tracking effort. The present invention provides this capability.

Triangulation systems using a fixed point and a mobile homing vehicle are always obliged to use one fixed antenna. The precision in locating the target is not as good, as the homing vehicle does not know its correct position. Since the calculation of the target location is made at the fixed antenna site, the use of direction finding equipment linked to proximity detectors is necessary at the homing vehicle.

U.S. Pat. No. 5,345,245 to Ishikawa et al. describes a differential ranging system in which a fixed reference with a known position transmits a corrective factor to a mobile station. The system depends upon a fixed station and hence lacks flexibility and true mobility of all parts of the system. Similarly, U.S. Pat. No. 5,111,209 to Toriyama relates to a satellite-based position determination system that is dependent upon fixed stations. The present invention overcomes these drawbacks by providing true mobile tracking capabilities, without the dependency on a fixed antenna or proximity detectors to locate the target, and wherein each of the mobile tracking stations can precisely locate and map the position of the target. As used herein, the term “mobile” when referring to a tracking and positioning station refers to a station that has the ability to physically move from one place to another, whether the communication and positioning equipment that constitutes a “station” is installed in a car, an aircraft, a boat, or even carried by a person. The present invention operates to determine the position of the station on (or above) the surface of the earth.

The invention includes a plurality of place sensors in which each sensor is software driven and in which the executable code that operates the sensor is downloaded through a data channel. The sensors can then be set up, configured, managed, or changed independently or as a system. This would allow the addition of a new sensor to be accommodated in a deterministic and predictive manner.

1. A Personal Location Apparatus and Method for Orientation

Current Geode Components

2 axis direction sensor chip Honeywell (HMC1022)

1 axis direction sensor chip Honeywell (HMC1021)

2 axis Tilt Sensor Analog Devices (ADXL202E8)

Temperature Sensor National LM61

MMC Connectors and Cards

Power Indicator LEDs

DSP

GPS

Current and Anticipated Functions Employing above Components:

GeoPointing Device—provides means of finding azimuth and elevation of any point with respect to the user's location.

Inertial Guidance Device—Provides heading and acceleration information from which speed and direction could be calculated independent of the GPS.

Kinetic Input Device—Information from tilt sensor can be used to provide commands to processor, i.e. shaking, or a given roll and/or pitch position could be used to turn devices or functions on or off, etc.

Flashlight and/or signaling device—Indicator LED's can have multiple uses to indicate proper operation of hardware, as a Flashlight and/or emergency signaling device. (high intensity LED)

Thermometer

Thermal shutdown capability

Map orientation with magnetic compass when stationary and with GPS information when moving

Time and location stamping of any of the above information

Storage of any of above information on MMC—portable to other devices

Expansion capability through MMC connector—could connect other serial devices such as disk drive, printer, etc.

Planned additions in future versions may include hardware additions such as audio and video codecs, a speaker or earphone jack and an integrated video camera, and functional possibilities such as voice commands and response and GeoStamping of video and audio information.

The Geode is a GeoContent appliance wherein the GeoContent is defined as geospatial information that includes location and orientation (including compass bearing) and/or temperature. It includes a method for orienting a point of reference with relation to a plurality of points, objects, areas, or places, based on the Geode device capabilities, namely, the location (provided by the GPS), the heading (provided by the Inertial Guidance Device), and the azimuth (provided by the Kinetic Input Device). This can include two-dimensional maps with only the location and heading, or include three-dimensional maps, if the azimuth is included.

Each of the following are believed to be patentable inventions based on patent research that was done by the MRT IP team.

A. Association of Content, Computing Resources, Services or Personalized Attributes with a Geo-Spatial Location

This invention includes a method and apparatus for targeting or associating computer content, computing resources, or computing services to a plurality of absolute points in space. Further, a point could be a region of space or a constriction of space, the points could have associated attributes, and the plurality of points could comprise those points that have attributes in common. The associated points of interest that have specific attributes could take into consideration a person that has specific attributes and that person's preferences, and the proximity could be further defined or refined by DNA-based matching criteria.

The invention may also include a secure photographic registry wherein the user that registers a photo includes a GeoDiscovery record that includes location, authorization and discovery (SLP-like), and other information. The registry users can search for photos based on information provided by the person who registered the photo, by photo publishers, or by other users. Using the photo registry, users can obtain information on one or more photos and download that information as a GeoDiscovery record to a Geode.

B. Delivery of Content Via a Network Broadcast or Narrow-cast Transmission and Receiver Method and Apparatus

This invention would enable information or content to be delivered to a user's location-aware network node or location-aware network appliance. It would enable users to inquire about or find content, services or products available at a specific point on the globe, or within a proximity or measurable distance from a point on a globe. The proximity could be further defined or refined by geographic data, demographic data, historic data, religious data, and/or business purpose or type, and use a computer algorithm to map genetic information to a computer-based service.

C. Geo-Coding, Searching/Sorting, or Identifying and Item Based on Location

This invention facilitates business-to-business, business-to-consumer, or consumer-to-business exchange of a service, product, or content associated with an absolute geographic point on the earth or to a measured distance or proximity to an absolute geographic point on the earth when that point is identified by latitude and longitude numbers, or when that point is identified by latitude and longitude and elevation numbers.

D. (Synchronize Based on a GPS, Node Network)

The invention uses a computer display and GPS/compass to create a GUI that shows landmarks or celestial/star formations based on the device's orientation or the direction in which it is facing rather than using maps as prior inventions have used.

The system includes a secure photographic registry wherein a user that registers a photo includes a GeoDiscovery record that includes location, authorization, discovery (SLP-like) and other information. The registry users can search for photos based on information provided by the person who registered the photo or by photo publishers, or other users. Using the photo registry, users can get information on one or more photos and download that information as a GeoDiscovery record to a Geode.

An on-line scanner that's built into the geode and reads printed characters or numbers from print and derives location information+(latitude, longitude, altitude, distance from, etc.).

E. Virtual Experience Recorder

The following are definitions that will help you understand the descriptions below:

A point could be a region of space or a constriction of space.

A plurality of points would comprise those points that have one or more common attributes.

A location is point.

A trail of points is a plurality of points that are in a location-based ordered sequence.

The invention can record and recreate the physical environment at a location or within proximity of a location. This data from this apparatus could be used to enhance a computer application or a human interface with a computer system, whether that computer system is a single computer or a network of computer systems or services. This capability could be recreated across a network such as the Internet or Web.

The Virtual Experience Recorder (VER) is an apparatus that has a GPS receiver and one or more sensor components. The apparatus monitors, outputs, or transmits the sensor component(s) output(s) to a computer or one or more recording devices.

The device is a hardware apparatus that senses, monitors, transmits, outputs and records the physical the physical location, position, and/or orientation of an object.

The value of this invention is that it can record the physical environment of a particular location or proximity and be able to remotely represent, recreate, replay or reenact the elements of the environments for the benefit of software applications or services.

An obvious exclusion of the invention would be a GPS combined with a GSM based communication device.

The Virtual Experience Recorder (VER) is an apparatus that has multiple sensor components or recording devices. This apparatus can then monitor the data or information being produced by the sensor component(s) and then send that data to a data log file and/or one or more recording devices.

The apparatus initially starts as a simple Global Positioning System (GPS) receiver that determines its location based on the signals received from the network of satellite-based GPS transceivers. From the GPS signal(s), the apparatus can also calculate time.

Time data could be used to create an accurate clock for the apparatus, and the apparatus may include a digital compass, a digital thermometer, and an altimeter. The apparatus may also include an ultrasonic receiver that can measure the distance of the apparatus from an ultrasonic transceiver and three or more ultrasonic receivers that can simultaneously measure the distance of the apparatus from three or more. Further, the apparatus may include a light sensor that can measure the amount of light on the apparatus, a heat sensor that can measure the heat immediately around or near the apparatus, an infrared heat sensor that can indicate that an object that has a measurable temperature is within a proximity of the apparatus and is located in the direction that the infrared heat sensor beam is pointing, a wind speed indicator that can output how fast the air is moving at the spot where the apparatus is located, a radar unit that can indicate an object is in proximity to the apparatus, and a humidity sensor. The apparatus may also include a microphone or audio sensor, a two-way voice radio service or Family Radio Service (FRS) transmitter and/or receiver that operates in the 460 MHz band, a Range-Image sensor, a video player device, a video-recording device, remote motion sensor, and a codec or other digital sound “player” microprocessor.

F. Security Capability for Geo-Environment

The invention includes a method of digitally signing information entered into a PDA and/or a method encrypting information for a PDA that could only be decrypted/viewed at a specific location. The invention has the capability of mapping medical, consumer, logistical, and other information to a geographic location and creating computer algorithms that would do the mapping.

1. For full functionality (and security), this operation would require a Geode with non-tamperable qualities including non-FLASH ROM and a tamper-resistant casing, possibly an epoxy-filled case to prevent damage if the device falls or is destroyed by opening.

2. A unique private key (from a public/private key pair) is stored securely (can't be accessed outside of the Geode) on a ROM in the Geode.

3. Public key cryptographic routines (RSA, elliptic curve, etc.) are used by the DSP or ARM processor on the Geode to combine the date/time, location, and hash of the information to be signed (from the PDA) and encrypt this information using the private key, thereby effectively signing the information.

4. The public key, available from a PKI or directory, could be used to determine at any time later whether the information (including date/time and location) had been modified.

5. A graduated trust level system will assign a level of trust, based on the model of the Geode hardware and uniqueness and privacy of the private key, to the digital signature.

A unique feature of the device is that it includes a cryptographically secure method of signing information with date/time and location.

Among the valuable features of the invention is that it is capable of digitally signing information with a date/time and location, which extends the digital signature concept to allow one to not only know who created the information but also when and where the information was created. This allows for non-repudiation as well as data integrity—guaranteeing an inability to disavow a transaction and confirming that the information was not tampered with or altered.

Location based encryption would allow specific information to only be decrypted when at a specific location (or within a specified distance from that point). Specific examples could include “on-site” coupons, where the consumer must be at a specified site for the coupon to be valid, and time-based release of information, where information would be decrypted only after a specific date/time had passed.

An obvious exclusion of the invention would possible be a cryptographically secure way to digitally sign information with a date/time. The invention may include a cryptographically secure way to digitally sign information with a location and possibly date/time, a device (similar to smart-cards) that protects the internal CPU and private information from functioning or revealing the private key if tampered with, a method for determining the quality of the GPS signal and number of satellites attached to prevent or reduce the possibility of spooling, and a method for encrypting/decrypting information only at or near a specific location. Location and/or date/time information is combined with the private key to allow content to only be available in specific locations or at certain times.

Note: These prior patents were found primarily on www.patents.ibm.com using (location and digital signature) or (location and encryption) searches.

1. U.S. Pat. No. 06,039,248—Mar. 21, 2000—Method for preparing safe electronic notarized documents in electronic commerce

2. U.S. Pat No. 06,009,524—Dec. 28, 1999—Method for the secure remote flashing of a BIOS memory

3. U.S. Pat. No. 05,910,989—Jun. 8, 1999—Method for the generation of electronic signatures, in particular for smart cards

4. U.S. Pat. No. 06,031,914—Feb. 29, 2000—Method and apparatus for embedding data, including watermarks, in human perceptible images

5. U.S. Pat. No. 05,905,800—May 18, 1999—Method and system for digital watermarking

6. U.S. Pat. No. 05,606,609—Feb. 25, 1997—Electronic document verification system and method

7. U.S. Pat. No. 04,850,018—Jul. 18, 1989—Security system with enhanced protection against compromising

8. U.S. Pat. No. 05,640,452—Jun. 17, 1997—Location-sensitive decryption of an encrypted message (Trimble)

9. U.S. Pat. No. 05,995,630—Nov. 30, 1999—Biometric input with encryption

10. U.S. Pat. No. 05,754,657—May 19, 1998—Authentication of a message source (Trimble)

G. Geo-Commerce

The invention facilitates business-to-business, business-to-consumer, or consumer-to-business exchange of a service, product, or content associated with an absolute point geographic point on the earth, or to a vectored distance within a specified proximity to an absolute geographic point on the earth.

H. Text Tied to a Location

This invention has the ability to tag a textual description to a point, location, plurality of points, or trail of points, where a point could be a region of space or a constriction of space, or a location could be a point, where a plurality of points or locations could comprise those points that have one or more common attributes or could be a multi-dimensional area or sphere, and where a trail of points are a plurality of points that are in a location-based ordered sequence.

I. Multiple Mode Based Routing

The invention includes a method for determining route based on mode of travel or transport. The result could be an itinerary for a trip that includes several legs of the trip where each leg is based on a different mode of transport.

J. Electronic Travel Documentation Assistant

The author of travel content can quickly gather, associate and include geographic data to be included in facts and figures related to a destination or area traveled. This is accomplished by using the Geode to capture and upload travel relevant data to the Internet, and could be via a handheld or via a mobile wireless computing device. A unique feature of the invention is that it allows content authors to quickly gather geo-related data for inclusion with their articles. The value of this invention is that readers can easily spot data that they may have interest in. Further, a consistent presentation adds familiarity for the reader regardless of the author or the content publisher.

K. Geographic Pointer Device

A geographic pointing or aiming device consists of a PIM/PC/EC, a geographic database with topological and/or street information and points of interest, a GPS or other positioning device, a 3-D compass or compass and slope indicator, gun sights or an attachment mechanism to a telescope or binoculars, a triggering button or lever and a plurality of output devices including a display, voice or other output. This device allows the user to point to natural or man-made objects such as a mountain, river, trail, building or statue and have the objects identified by name and other characteristics.

### Geographic Pointing Device

Continuing advances in computer technology have created functional computers that fit in a shirt pocket and weigh less than 5 ounces. These hand-held devices are called Personal Information Managers (PIM's) or Personal Digital Assistants (PDA's). Further miniaturization is resulting in wristwatch-size computers. PIM's are easy to carry around and offer a wide variety of functions including calendars, schedules, phone lists, finances, to-do lists, memos, on-line books and computer games.

In a related development geographic information is being made available. A Global Positioning Satellite (GPS) receiver is a small portable electronic device that receives signals from Geo-synchronous and other satellites and determines the location on the earth where a person currently is located (e.g. latitude, longitude and altitude). Such a device can even provide direction and speed of movement. If it is provided with a destination location, the direction to head and the distance that must be traveled to reach that destination can be displayed.

A GPS receiver is often linked to a computer containing locational databases such as street maps, topographic information, points of interest and path/route information. With this configuration a map can be displayed showing the origination and destination points and the progress made in reaching the destination. Linking a GPS receiver to a PIM is attractive because both devices are small and provide a portable and convenient system for traveling from one point to another.

With some effort a person with a GPS/PIM system who is in an unfamiliar environment can attempt to identify points of interest such as buildings, mountains, rivers, statues, etc. To be identified these objects must be properly positioned and identified on the map and the user must be able to properly orient the map and recognize the object.

The invention includes a method of identifying natural geographic or man-made objects and of displaying these objects to the user of the GEO-Pointer, and a system or device which allows a user to point to an object and to have that object identified for the user. The device may be incorporated with or attached to binoculars and telescopes and may provide gun sights. It would assist users who need the azimuth and elevation, latitude and longitude, and other geographic information for their location, and could identify an object that is pointed to. This information would be output by a display on screen or via an auditory method, and could be combined with location-identifying information or signals such as GPS, radio or other signals. Information for a target location relative to the base location could be provided if a digital compass, digital azimuth sensor, palm device, and GPS are present at the base location.

L. Geographic Image Timestamp Identification

The invention may include a method for stamping a photographic or other image with temporal, geographic and other information. An apparatus is also disclosed which, when attached to or integrated with a camera, records the date and time, the geographic position (e.g. latitude, longitude and altitude), the direction in which the camera is pointing, and other identifying information. For existing images, this temporal and geographic information is estimated and then associated with the image. For images created with the disclosed apparatus, the temporal, geographic, aspect and other information is created automatically and attached to the image. The apparatus consists of a clock, a GPS or other positioning device, a 3-D compass or other aspect measuring device and the necessary recording and control logic. With this invention, one can determine when, where, and in what direction an image was created and can compare the image with images created at earlier or later times or with other aspects or from related locations.

### Geo-Timestamps for Images

Devices of this type may include a system or device which allows a user to point to an object and to have that object identified for the user.

M. Geographic Location Storage Area Network (SAN)

Data is migrated to the edge of the Web or Internet, or on to the user devices or systems based on the location of the device, the bandwidth of the communication channel to the device, or the nature of the data involved in the presentation of the user experience.

N. Transaction-Based Duel Bay Content Copier

Data is copied from one MMC slot to another with the ability to charge for copyrighted or branded content that is copied. The transaction and accounting information is uploaded immediately for wireless platforms or at the next synchronization episode for handhelds.

O. Location-Based Network Search

This works by using the individual's location to search on the network.

P. GPS Control Mechanism for Geo-Spatial Computing Services and Applications

This is a software MUX that uses location and type of content, either a software service or an application, to determine what will be executed on the platforms processing unit. The type of content could be determined by scanning the content, or looking for well-known tags or descriptor fields in the content.

Q. Applying the Geospatial Information to a Directory

This would use the features of a directory to store and retrieve location or geospatial information.

What is claimed is:

1. A geographic pointing device comprising:
a locator means;
a direction means; and
a trigger means.

2. The geographic pointing device of claim 1, further comprising a data processing unit.

3. The geographic pointing device of claim 11 wherein the locator means comprises a GPS receiver.

4. The geographic pointing device of claim 1, wherein the direction means comprises a compass.

5. The geographic pointing device of claim 4, wherein the compass is digital compass.

6. The geographic pointing device of claim 5, wherein the digital compass is a single axis direction sensor.

7. The geographic pointing device of claim 5, wherein the digital compass is a dual axis direction sensor.

8. A location receiver and direction sensor combination apparatus for receiving location, direction and orientation information independent of the location receiver, the location receiver and direction sensor combination apparatus comprising:
a location receiver for providing location;
a direction sensor for providing orientation to the magnetic north pole of the earth;
a trigger for starting or stopping the apparatus.

9. A location receiver and direction sensor combination of claim 8 wherein the said direction sensor is a one axis magnetic sensor.

10. A location receiver and direction sensor combination apparatus of claim 8 wherein the said direction sensor is a two axis magnetic sensor.

11. A location receiver and direction sensor combination apparatus of claim 8 wherein the said trigger is connected to an external device by a signal connection and the external device provides a signal that is used as the trigger.

12. A location receiver and direction sensor combination apparatus of claim 8 wherein the said direction sensor provides directional, orientation, or bearing information.

13. A location receiver and direction sensor combination apparatus of claim 8 wherein the location receiver is a global positioning system receiver for receiving a GPS signal including information for a GPS location.

14. A location receiver and direction sensor combination apparatus of claim 8 wherein said direction sensor is adapted to include a two axis direction sensor information.

15. A location receiver and direction sensor combination apparatus of claim 8 wherein the GPS receiver for providing location is adapted to additionally provides time information as digital information.

16. A location receiver and direction sensor combination apparatus of claim 8 wherein the location receiver is a data storage buffer wherein the location information is stored as digital information.

17. A location receiver and direction sensor combination apparatus of claim 8 wherein the said trigger is adapted to provide a signal to be detected external of the location receiver and direction sensor combination apparatus of claim 1.

18. A location receiver and direction sensor combination apparatus of claim 8 including a method for providing a corrected compass reading based on the true north for the location provided by the location receiver.

19. A location receiver and direction sensor combination apparatus of claim 8 including a method of transmitting the location, direction and orientation information.

20. A location receiver and direction sensor combination apparatus of claim 8 wherein said trigger is adapted to be a data processing unit.

21. A location receiver and direction sensor combination apparatus of claim 8 wherein said trigger is adapted to be a digital signal processor (DSP) unit.

22. A location receiver and direction sensor combination apparatus of claim 9 wherein said direction sensor is adapted to be a data storage buffer wherein the bearing information is stored as digital information.

23. A location receiver and direction sensor combination apparatus of claim 8 including a method for locating and presenting the location and bearing.

24. A location receiver and direction sensor combination apparatus of claim 19 including and output means for outputting the location and direction sensor information.

25. A location receiver and direction sensor combination apparatus of claim 20 wherein the output means for outputting the location and direction sensor information is stored in an information storage buffer as digital information.

26. A location receiver and direction sensor combination apparatus of claim 12 wherein the trigger is adapted to use the time information from the GPS receiver.

27. A location receiver and direction sensor combination apparatus of claim 8 including a method for determining the location of a remote object displaced from the location receiver and direction sensor combination apparatus.

28. A method for determining the location of a remote object as of claim 24 wherein the location receiver is adapted to include a location information for a plurality of remote objects.

29. A method for determining the location of a remote object as in claim 24 wherein the method for determining the location of a remote object is accomplished with the addition of a visual remote location device.

30. A method for determining the location of a remote object as of claim 24 wherein the method for determining the location of a remote object is accomplished with the addition of an electronic remote location device.

31. A method for determining the location of a remote object as of claim 24 wherein the method for determining the location of a remote object is accomplished with the addition of an acoustic remote location device.

32. A method for determining the location of a remote object as of claim 24 wherein the method for determining the location of a remote object is accomplished with the addition of an Infrared (IR) remote location device.

33. A method for determining the location of a remote object as of claim 24 wherein the method for determining the location of a remote object is accomplished with the addition of a light wave, light particle or laser beam remote location device.
